(19) United States
(12) Patent Application Publication
(10) Pub. No.: US 2006/0246774 A1
(43) Pub. Date: Nov. 2, 2006

(54) Coaxial cable connector assembly, system, and method

(76) Inventor: Bruce D. Buck, Woodbridge (CA)

Correspondence Address: KRIEG DEVAULT LLP, ONE INDIANA SQUARE, SUITE 2800, INDIANAPOLIS, IN, 46204-2079, US

(21) Appl. No.: 11/152,865

(22) Filed: Jun. 14, 2005

Related U.S. Application Data
(60) Provisional application No. 60/676,497, filed on Apr. 29, 2005.

(51) Int. Cl. H01R 9/05

(52) U.S. Cl. 439/578

(57) ABSTRACT

One embodiment of the present application is an assembly that comprises a threaded connection component, a coaxial cable, and a coaxial cable connector. The coaxial cable includes an outer insulator, an inner insulator, an outer electrical conductor positioned between these insulators, and an inner electrical conductor extending through the inner insulator. The connector includes a body defining a chamber and an opening that is configured to receive the cable. The connector includes a fastener rotatably connected to the body opposite the opening that has internal threading engaged by the threaded connection component, and a cable engagement device captured within the chamber. This device includes a mandrel with a head. A mandrel end opposite the head penetrates the coaxial cable and is secured between the outer and inner insulators thereof in response to compressive force exerted on the head by advancing the threaded component into the fastener.

### CROSS-REFERENCE TO RELATED APPLICATIONS

The present application claims the benefit of U.S. Provisional Patent Application No. 60/676,497 Filed 29 Apr. 2005, which is incorporated by reference in its entirety herein.

### BACKGROUND

This invention relates generally to connecting devices for coaxial cable, and more particularly, but not exclusively, relates to devices, methods, assemblies, systems, and methods for providing a connector on the end portion of a coaxial cable. Such connectors can be of the type used for cable and satellite TV transmission, including, but not limited to F-connectors that are commonly used to connect flexible coaxial cable in cable and satellite TV signal distribution systems, just to mention one example.

Flexible coaxial cable is used extensively in cable and satellite television distribution systems. Such cable consists of a central conducting wire, a dialectic insulator encasing the central conductor, at least one aluminum tape shield and one braided shield around the dialectic insulator, and a jacket covering the braided shield.

Common 75 ohm flexible coaxial cable, such as RG-59 type, is typically used for drop lines from tap devices on trunk line feeders to customers' homes. Such coaxial cables are usually connected by Type F connectors. F-connectors come in different configurations but most commonly consist of a male plug that is mounted to the coaxial cable, and a female jack or socket which is assembled to a tap or other electrical device, such as a ground block or a cable splice coupling unit. The female jack is commonly referred to as an F-port. The F-port includes an internal clip pin or other electrical contact mechanism that receives the central conductor of the coaxial cable extending from the male plug. The internal contact mechanism is insulated from the body of the F-port and provides an electrical connection from the central conductor of the coaxial cable to the circuit within the electrical device.

When used in certain outdoor environments, there is a risk that moisture can penetrate between the F-port and the male plug leading to potential signal loss and deterioration of the circuitry. Various means have been proposed to combat such moisture penetration. In some cases, for example, an outer jacket or boot is mounted on the F-port and then pulled back to cover a portion of both the F-port and the male plug after the cable has been installed. Other means include paint on sealants and heat activated shrink sealing tape. All of these known means for preventing moisture penetration between the mating components of an F-connector suffer from the disadvantage of being awkward and time consuming to apply, particularly in field installations and in inclement weather. Moreover, in the case of some of the known moisture barriers, subsequent removal of the cable permanently destroys the seal.

Frequently, the reliable attachment of a connector to the free-end of a coaxial cable requires use of a special installation tool. Installation by hand can be desired in certain instances as an addition or alternative to hand tool usage. In some implementations, connectors installed by hand may be of a variety without seals of the type described above, while in others such features may be optional and/or additionally desired.

Thus, there remains a need for further contributions in this area of technology.

### SUMMARY

One embodiment of the present invention includes a unique coaxial cable connection technique. Other embodiments include unique methods, systems, assemblies, apparatus, and devices to attach a connector on a coaxial cable. Accordingly, one object of the present application is to provide a unique coaxial connection technique. Alternatively or additionally, another object of the present application is to provide a unique method, system, device, assembly or apparatus for attaching a connector on a coaxial cable. Further embodiments, forms, features, aspects, benefits, objects, and advantages of the present application shall become apparent from the detailed description and figures provided herewith.

### BRIEF DESCRIPTION OF THE DRAWINGS

FIG. 1 is a cross-sectional side view of an F-connector assembly according to one embodiment of the present invention, comprising an F-port and an unattached connector plug mounted to a coaxial cable;

FIG. 2 is a cross-sectional side view of the fully attached connector assembly of FIG. 1;

FIG. 3 is a perspective view of a multi-port tap device with coaxial cables connected thereto by means of F-connector assemblies according to the same embodiment of the present invention;

FIG. 4 is a perspective assembly view of a coaxial cable connector of another embodiment of the present invention;

FIG. 5 is a sectional view of the connector of FIG. 4 after assembly;

FIG. 6 is a partial cutaway view of the connector of FIG. 4; and

FIG. 7 is a partial cutaway, sectional view of a coaxial cable connection assembly including the connector of FIGS. 4-6.

### DETAILED DESCRIPTION OF REPRESENTATIVE EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations or further modifications of the described embodiments, and any further applications of the principles of the invention as described herein are contemplated as would normally occur to one skilled in the art to which the invention relates.

In accordance with one embodiment of the present application, an F-connector assembly is provided for installing a flexible coaxial cable to an electrical device. The connector comprises a generally cylindrical F-port body, with an electrical contact mechanism therein, and a sealing ring disposed around the body.

The body has an outer portion with a threaded end for receiving a mating coaxial cable connector plug, and an inner portion configured for assembly to the electrical device. The internal contact mechanism is insulated from the body of the F-port and includes a clip pin or other means for receiving the central conductor of a connected coaxial cable. The electrical contact mechanism provides an electrical connection from the cable to the circuit within the electrical device.

The sealing ring is disposed around the outer portion of the body of the F-port, positioned so as to create a seal with a mating coaxial cable connector plug when the plug is attached to the F-port.

Preferably, the sealing ring is in the form of an O-ring that is retained in a recess adjacent the threaded end of the outer portion of the F-port body. Advantageously, the O-ring has an internal diameter of 0.300 inches and a cross-sectional diameter of 0.045 inches.

Most preferably, the F-connector assembly also includes a coaxial cable plug mounted or mountable to a coaxial cable, having a rotatable nut with internal threads that mate the threaded end of the F-port body for joining the connector plug to the F-port. The nut of the connector plug can have a non-threaded rim extending forwardly from its inner threads to engage and seal to the sealing ring when the connector plug is joined to the F-port. In accordance with another aspect of the present application, there is provided a method of installing a flexible coaxial cable to an electrical device by means of F-connector, which comprises the following steps: providing an electrical device with an F-port assembled thereto, the F-port having a generally cylindrical body with an outer threaded end, and an insulated internal electrical contact mechanism for receiving the central conductor of an attached coaxial cable and providing electrical connection to the circuit within the electrical device, and having an O-ring disposed around the F-port body adjacent its threaded end; joining the coaxial cable to the F-port by attaching a mating connector plug mounted to the cable, the plug having a rotating nut which is fastenable to the threaded end of the F-port body; and tightening the nut of the connector plug so that it contacts and seals to the O-ring of the F-port.

It has been found that the F-connector assembly and installation method of the present invention provides an effective and economical solution to the problems presented by known prior art F-connectors, as described above. Because the F-port includes the sealing ring as an integral part, installation of the coaxial cable requires no additional components, tools, or manipulation to realize a moisture barrier when such barriers are desired. Simply attaching the cable connector plug by means of its threaded nut engages the sealing ring to create an effective seal between the F-port and the cable connector plug.

In still another aspect of the present application, for certain applications it is desirable to provide a reliable connector that can be attached to a coaxial cable without the need to use an installation tool. In some implementations, this type of connector may be desired without seals of the type described above, while in others such features may be optional and/or additionally desired.

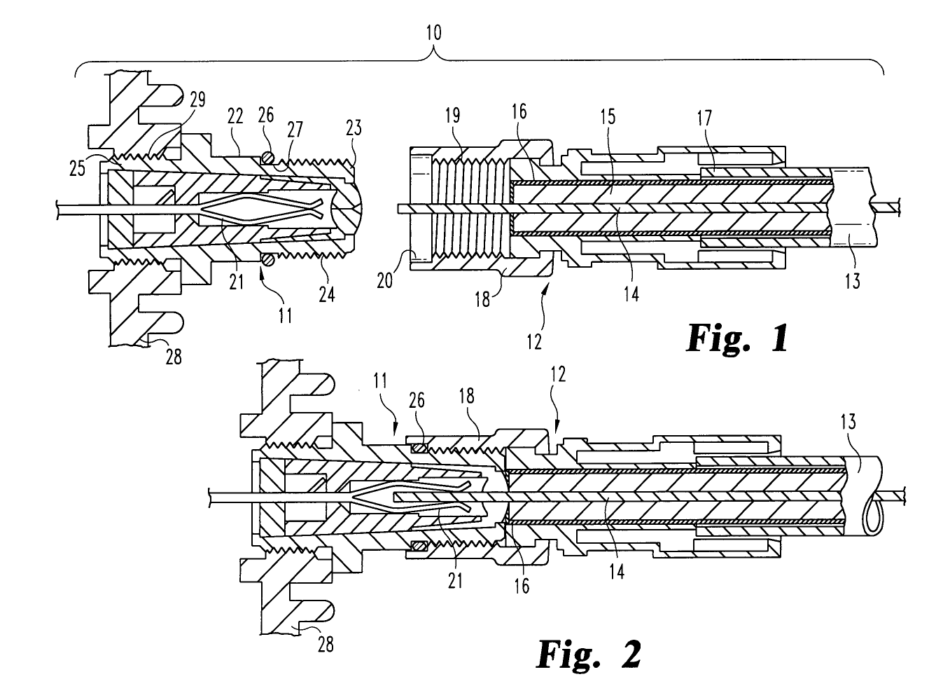

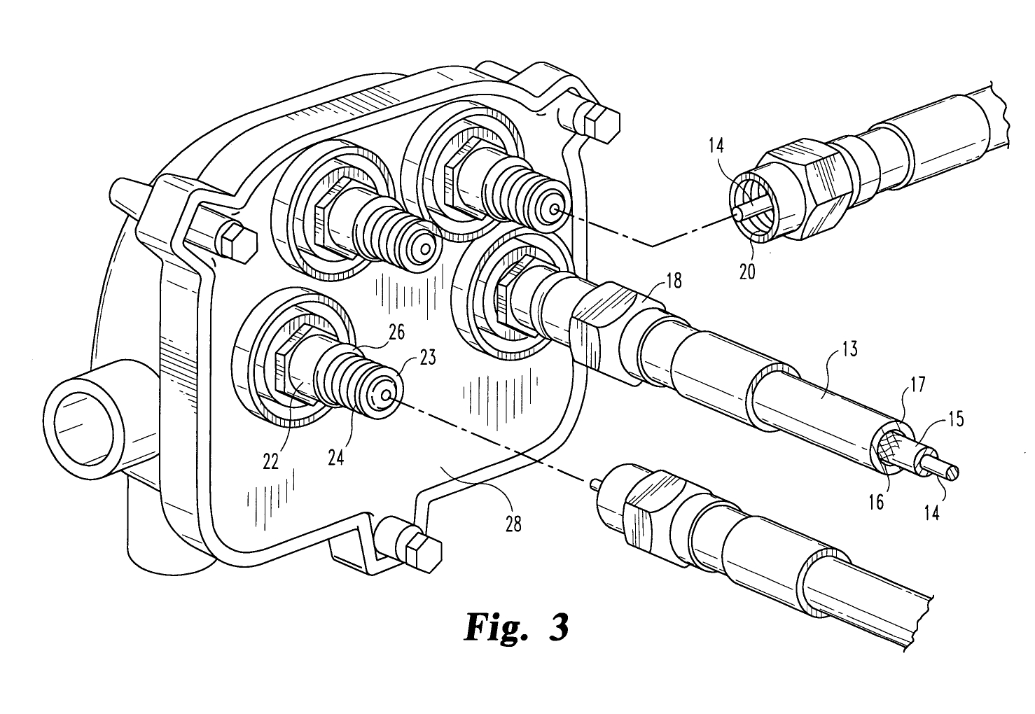

As shown in FIGS. 1-3 of a further embodiment of the present application, F-connector assembly 10 includes an F-port (or jack or socket) 11 and a plug (or male connector) 12. The F-port is assembled or assembleable to a multi-tap distribution device 28.

The plug 12 is shown mounted to a coaxial cable 13 which has a central conductor 14, a dielectric insulator 15 encasing the central conductor, a braided shield 16 around the dielectric insulator, and a jacket 17 covering the braided shield 16. The F-connector 10 of the present invention is intended for use with coaxial cable, such as RG-59 and RG-6 type cables and also RG-7 and RG-11 type cables, to name just a few examples.

The plug 12 mounts to the coaxial cable 13 so as to form a moisture-resistant seal, as taught for example by the inventor's U.S. Pat. No. 6,261,126. The plug 12 has a brass body and includes a rotatable nut 18, also brass, with internal threads 19 by means of which the plug 12 may be fastened to the F-port 11. The plug 12 mounts to the coaxial cable 13 with a portion of the central conductor 14 extending forwardly of the rotatable nut 18 for engagement within the F-port 11.

The F-port 11 has a generally cylindrical brass body having an upper portion 22 to which the male connector plug 12 may be attached, and a lower portion 25 configured for assembly to an electrical device, such as a multi-tap 28, by threads 29. The upper portion has a threaded end 23 with standard UNF threads 24 that mate with the threads 19 of the rotatable nut 18 on the cable plug 12. A rubber O-ring 26 is disposed around the upper portion 22 of the body 21 of the F-port 11, retained in a groove 27 adjacent the threaded end 23.

One nonlimiting embodiment is dimensioned in accordance with the following: the O-ring 26 has an internal diameter of approximately 0.300 inches and a cross-sectional diameter of about 0.045 inches, with the diameter of the upper portion 22 of the F-port body 21 being approximately 0.384 inches, and the diameter of the groove 27 being approximately 0.3175 inches. The inner diameter of the non-threaded rim 20 of the rotatable nut 18 of the plug 12 is approximately 0.388 inches, and the outer diameter of the rotatable nut 18 is approximately 0.433 inches, for this dimensioned example. Naturally, in other embodiments, different device dimensioning may be utilized as desired.

Within the body of the F-port 11 is a clip pin contact mechanism 21 insulated from the body 12. When the plug 12 is joined to the F-port 11, the contact mechanism 21 receives the central conductor 14 of the coaxial cable 13 and provides electrical connection to the circuit within the electrical device to which the F-port 11 is assembled.

As shown most clearly in FIG. 2, when the plug 12 is fully attached to the F-port 11 to install the coaxial cable 13 to an electrical device such as the multi-tap 28, the rotatable nut 18 of the plug 12 is screwed onto the threaded end 23 of the F-port 11. The non-threaded rim 20 of the rotatable nut 18 is brought into contact with the O-ring 26 and forms a moisture resistant seal therewith as the rotatable nut 18 of the plug 12 is fully tightened onto the upper portion 22 of the F-port 11.

For the depicted embodiment of FIGS. 1-3, no additional steps are required in installing a coaxial cable to an electrical device to realize a moisture resistant seal between the cable plug and the F-port. No additional components need be applied or manipulated, and no special tools are required.

It will of course be appreciated that many variations are possible within the broad scope of the present invention. For example, while in the preferred embodiment described above the F-port is assembled to the electrical device by a threaded engagement, it may alternatively be assembled by solid casting or a press fit.

A sealing ring other than an O-ring can be substituted. The configuration and placement of the sealing ring must though be contacted by the rim of the rotatable nut and form a seal therewith as the plug is fully attached to the F-port. The dimensions of the F-port body, the O-ring, and the retaining groove may also be modified while still providing an effective seal as will be apparent to those skilled in the art.

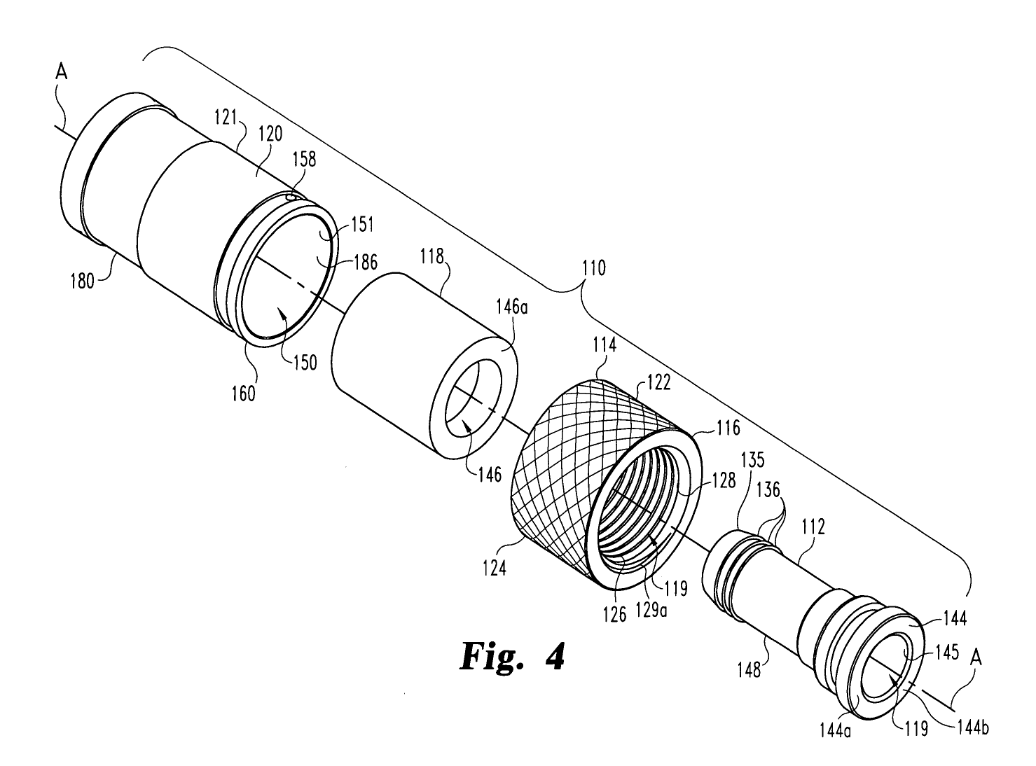

Furthermore, while both the plug and jack of the F-connector described above are made of brass, other materials could be substituted, provided they have the desired properties of strength, conductivity, surface hardness and corrosion resistance. In other embodiments directed to coaxial cable connection, a sealing ring or other moisture barrier may be absent, as shown and described in connection with FIGS. 4-7.

Referring to FIGS. 4-6, connector assembly 110 of a still further embodiment is illustrated. Assembly 110 includes tubular mandrel 112, cap 114 in the form of threaded fastener 116, tubular retainer 118, and tubular bushing 120 that are shown relative to assembly axis A in FIG. 4. Fastener 116 includes outer surface 122 defining knurling 124 to provide a secure contact for tightening by finger as will be more fully described hereinafter. Opposite outer surface 122, inner surface 126 defines threading 128 of fastener 116. Cap 114 includes passage 119 extending from opening 129a to opening 129b.

When assembled together, mandrel 112, cap 114, retainer 118, and bushing 120 provide connector 130 extending along longitudinal axis L. These components are each approximately cylindrical with a centerline axis corresponding to axis L. Mandrel 112 is positioned inside retainer 118 and includes end portion 132 opposite end portion 134. End portion 134 includes cable penetration end 135. Cable penetration end 135 defines barbs 136 and tapered termination 137. Tapered termination 137 defines aperture 138. Aperture 138 opens into passageway 140 that extends through mandrel 112. Barbs 136 are structured with an annular shape to engage a coaxial cable. In one application, this cable is of a standard configuration comprising a central conductor, a dielectric insulator with a foil cover concentrically surrounding this central conductor, a braided shield of one or more layers, and a plastic, organic polymer jacket, such as that described in U.S. Pat. No. 6,848,939; which is hereby incorporated by reference in its entirety. In other embodiments, cabling coupled with connector 130 can differ as would occur to those skilled in the art.

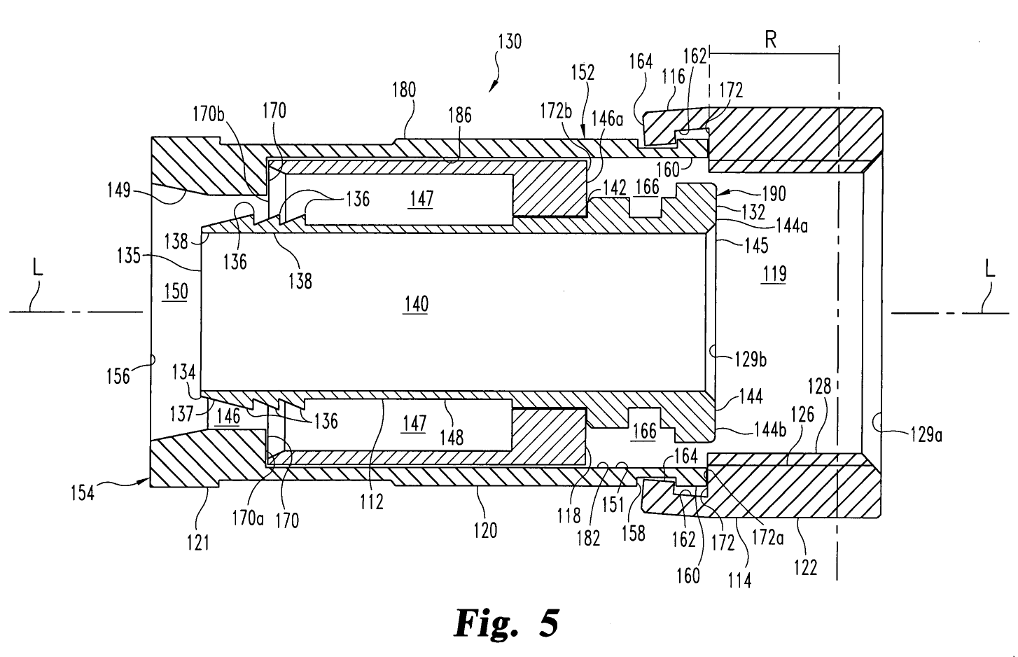

At end portion 132, mandrel 112 defines lip 142 and head 144 both of an annular shape. Head 144 is in the form of bearing member 144a defining bearing surface 144b. Head 144 defines aperture 145 opening into passageway 140 opposite aperture 138. As shown in FIG. 5, passageway 140 intersects passage 119 via aperture 145 and opening 129b. Retainer 118 defines passage 146 that receives mandrel 112 therethrough. A portion of passage 146 provides cavity 147 that circumscribes body portion 148 of mandrel 112. Retainer 118 includes rim 146a also of an annular shape that engages lip 142.

Bushing 120 is in the form of an outer tubular member 121 that defines passage 150. Member 121 defines body 180 of connector 130. Body 180 has internal wall 182 defining inner surface 151. Inner surface 151 apposes outer surface 181 defined by wall 182 of body 180. Inner surface 151 defines chamber boundary 184 of body chamber 186, which comprises passage 150. Chamber 186 receives both mandrel 112 and retainer 118, which collectively comprise cable engagement device 190. It should be understood that in other arrangements device 190 may be differently shaped and include more or fewer members or parts to perform the operations described herein.

Retainer 118 slidingly engages inner surface 151 of bushing 120. Bushing 120 includes end portion 152 opposite end portion 154. End portion 154 defines opening 156 to passage 150 that is structured to receive an end portion of a cable as further described hereinafter. In cooperation, end portion 134 of mandrel 112 and end portion 154 of bushing 120 define a tapered entry 149. At end portion 152, bushing 120 defines circumferential channel 158 bounded at one side by lip 160. Cap 114 defines inner channel 162 bounded at one side by lip 164. Lip 160 of bushing 120 engages channel 162 of cap 114 and lip 164 of cap 114 engages channel 158 to provide a slidable rotary attachment between bushing 120 and cap 114. Collectively, these structural features provide rotational coupling 192 that rotatably connects body 180 and fastener 116 together.

For the relative component positions shown in FIG. 5, connector 130 defines annular cavity 166 between bushing 120 and mandrel 112. For the FIG. 5 arrangement, it should also be appreciated that mandrel 112 can slide along axis L in translation over travel range R. Likewise, retainer 120 has a translational travel distance within bushing 120. End portion 152 of bushing 120 defines structure in the form of retainer stop 170, corresponding to one extreme of the retainer and mandrel travel range, and cap 114 defines retainer stop 172 corresponding to another extreme of the retainer and mandrel travel range. Retainer stops 170 and 172 define stop surfaces 170a and 172a of body 180 and fastener 116, respectively, that engage stop surfaces 170b and 172b of cable engagement device 190. Correspondingly, cable engagement device 190 remains captured within chamber 186 of body 180 between stops 170 and 172.

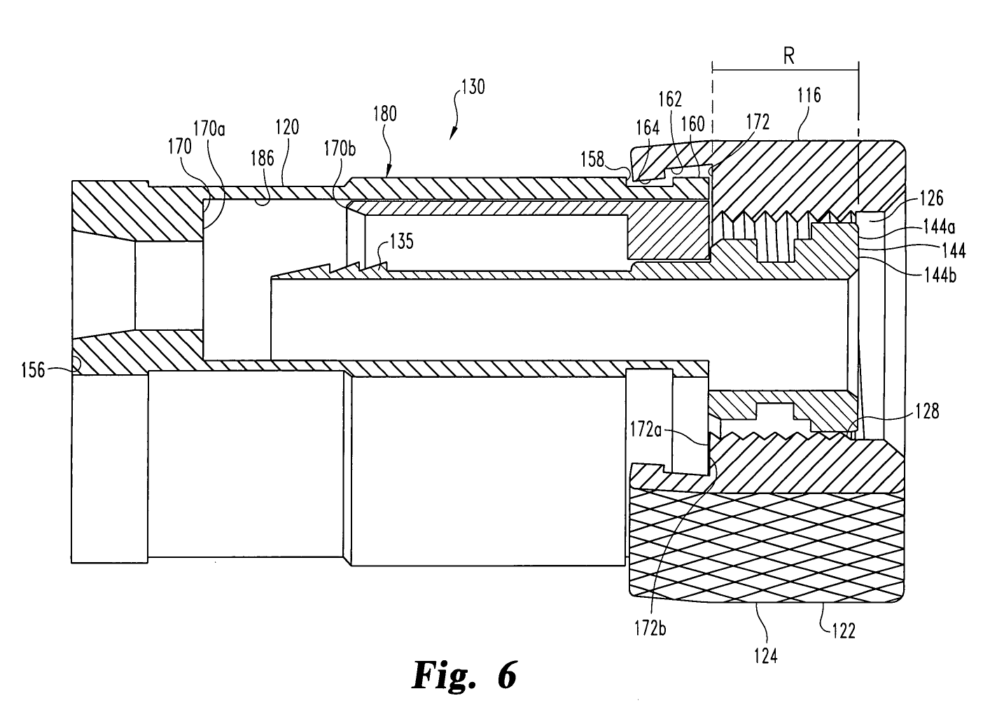

Referring generally to FIGS. 4-6, certain operational aspects of connector 130 are next described. In mounting connector 130 to cable of the type described in connection with U.S. Pat. No. 6,848,939, an appropriately prepared cable is inserted through opening 156 to engage end portion 134 of mandrel 112. Preparation can include stripping a portion of the outer layers of the cable to expose an end portion of a central connector. The concentric dielectric and foil layers are received within passage 140 of the mandrel 112. As mandrel 112 and the end of the inserted cable are forced together in compression, barbs 136 slide beneath the shield layer(s) and the jacket of the cable. Such compression can be provided by threading fastener 116 onto complimentary threading of an end of another connector (jack) structured to be received in passage 119 of cap 114. This threading operation begins by turning cap 114 by hand and/or by finger contact with knurling 124. As cap 114 is turned, the other connector advances towards end portion 132 of mandrel 112 and engages at least a portion of a central conductor extending away from mandrel 112. With further turning, the other connector contacts head 144 of end portion 132 and advances mandrel 112 to the left to the end of its travel range along axis L as defined by contact of retainer 118 with stop 170. This position is generally shown in FIG. 5 while positioning towards the opposite extreme of travel range R is shown in FIG. 6. The fastener 116 is turned manually until tight.

As mandrel 112 and the cable are forced against one another with the tightening of fastener 116 to the other connector, barbs 136 provide a secure attachment to the cable that resists subsequent removal from connector 130. The separated end of the jacket of the cable and the shield are contained within retainer cavity 147, entering at tapered entry 149.

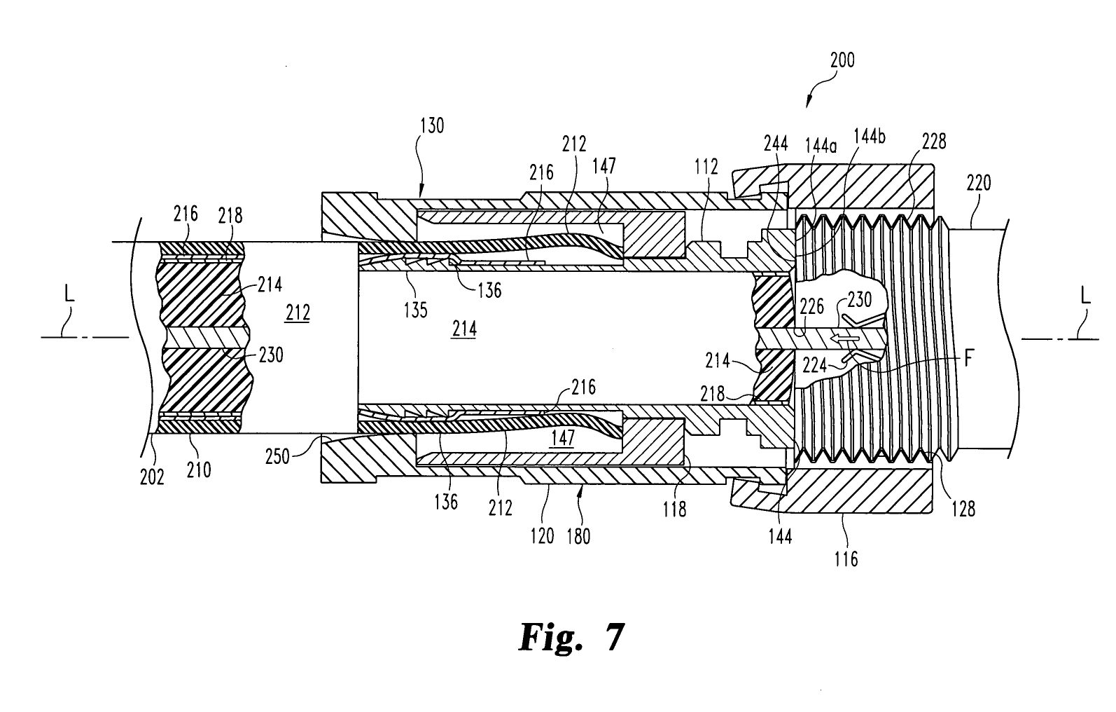

Referring also to FIG. 7, coaxial cable connection assembly 200 is illustrated; where like reference numerals refer to like features previously described. Assembly 200 illustrates connector 130 after installation to end portion 202 of coaxial cable 210 in the manner described in association with FIGS. 4-6. Cable 210 includes an electrically insulated jacket designated as outer insulator 212, a portion of which is received in cavity 147 of connector 130. Beneath this outer layer, cable 210 includes electrically conductive shielding 216 that surrounds outer conductor 218. Shielding 216 may be comprised of one or more layers and is typically in the form of a cylindrical braid, or the like; however, different forms may be utilized as would occur to those skilled in the art. Conductor 218 is typically in the form of a metal foil, or the like; however, this component may also differ as would be known to those skilled in the art. Conductor 218 surrounds inner insulator 214 that is typically comprised of an electrically insulating material selected for desired dialectic properties. Within insulator 214, is central electrical conductor 230 that is typically comprised of a solid metallic material.

Assembly 200 also includes threaded connection device 220 that may be a female portion of a connector for a splicing coupler, multi-port tap, splitter, or terminal end-use equipment, to name just a few possibilities. As shown in the cut-away view of FIG. 7, device 220 includes internal spring contacts 224 that are in electrically conductive contact with terminal end portion 232 of conductor 230. End portion 232 reaches contacts 224 through aperture 226 defined by device 220. Device 220 includes outer threading 228 and bearing surface 244.

As shown in FIG. 7, device 220 has been threaded into fastener 116, engaging threading 128 with threading 228. Through threaded advancement into passage 119, bearing surface 244 of device 220 makes contact with and bears against bearing surface 144b of head 144 (bearing member 144a). Correspondingly, a compressive force, symbolized by arrow F, is applied to device 190, which causes cable penetration end 135 to engage cable end portion 202 between its different layers as shown in FIG. 7. With the advancement of mandrel 112 into cable 210, barbs 136 secure engagement therein and the terminal end of outer insulator 212 and shielding 216 separated by mandrel 112 are positioned and contained within cavity 147. Insulator 212 and shielding 216 are further secured between end 135 of mandrel 112 and cable receiving collar 250 of body 190 by the resulting compressive wedging action or (pinching) that results from the application of axial force F. While device 220 makes direct contact with head 144 of mandrel 112, in other embodiments one or more additional parts may be positioned therebetween through which force is applied to penetrate cable 210.

Accordingly, as shown in FIGS. 4-7, a coaxial cable connection is provided that can be secured by hand-tightening without an installation tool. Instead, the threading together of connectors with fastener 116 provides a mechanical advantage to compress mandrel 112 and the cable end into a secure engagement. In one alternative embodiment, one or more seals are further provided by connector 130 in the form of one or more O-rings and/or one or more elastomeric components. In other alternative embodiments, the various other features and variations described in connection with FIGS. 1-3 and FIGS. 4-7 are interchanged or combined.

Still another embodiment includes engaging a coaxial cable end portion with a first end portion of a mandrel of a connector; engaging a head of a second end portion of the mandrel opposite the first end portion with a threaded end portion of another connector by turning a threaded fastener onto the threaded end, the threaded fastener being rotatably coupled to a tubular member of the connector that contains the mandrel; and advancing the threaded connector end to push the mandrel into the cable end to securely attach the cable end to the connector. In one form, the mandrel includes multiple barbs to engage the cable. Alternatively or additionally, the mandrel has a travel range through the connector that positions the head of the mandrel in the threaded fastener at one extreme thereof; and/or the threaded fastener has an outer surface defining knurling to facilitate tightening by finger.

Yet another embodiment is directed to a coaxial cable connector that includes a threaded fastener rotatably connected to an outer tubular member, a sliding retainer contacted within the outer member, and a mandrel. The outer member includes an opening into a passage that receives the retainer and the retainer includes a passage that receives the mandrel therethrough. The mandrel includes a first end portion with a number of barbs structured to slide into a coaxial cable end and a second end portion with a head structured to be engaged by an end of another connector threaded through the fastener. In one form, the mandrel head has a travel range through the connector that positions the head in the threaded fastener at one extreme. Alternatively or additionally, the retainer is fixedly connected to the mandrel and cooperates with structure inside the outer tubular member to provide stops for a range of travel of the mandrel as the mandrel is retained within the outer tubular member, and/or the fastener includes an outer surface defining knurling to facilitate finger tightening.

A further embodiment of the present application includes: providing a connector assembly having a body defining a chamber intersecting an opening, a fastener rotatably connected to the body and including an inner surface defining threading and a passage intersecting the chamber opposite the opening, and a cable engagement device inside the chamber that includes a cable penetration end opposite a head and defines an inner passageway therethrough. This embodiment further includes inserting a coaxial cable through the opening that has: an outer insulator, an inner insulator, an outer electrical conductor positioned between these insulators, and an inner electrical conductor extending through the inner insulator. The fastener threading is engaged by the threaded connection component to advance it through the passage and generate a force that is applied to the head of the cable engagement device. In response to this force, the cable engagement device moves through the chamber to push a portion of the cable engagement device between the outer insulator and the inner insulator such that the inner insulator and conductor extend through the inner passageway towards the fastener. Additionally or alternatively, this embodiment may include preparing an end portion of the coaxial cable before inserting it through the opening, inserting the inner conductor through an aperture in the connection component, securing the cable engagement device in the cable with barbs, providing the cable engagement device with the retainer member, slidingly engaging an inner wall of the body with the retainer, defining a cavity between the retainer and another portion of the device, and/or receiving at least a portion of the outer insulator in the cavity.

Still a further embodiment includes a tubular body extending along an axis that defines a chamber and has a first end portion opposite a second end portion. The first end portion defines an opening to the chamber that is structured to receive a coaxial cable therethrough. Also included is a fastener connected to the second end portion with a rotational coupling to turn about the axis relative to the body. This fastener includes an inner surface defining threading about the axis and a passage therethrough that intersects the chamber of the body. Further, a cable engagement device is included, which is captured within the chamber and has a retainer that slidingly engages the body and a mandrel including a head positioned opposite a cable penetration end. The head is positioned closer to the passage of the fastener than the cable penetration end, which is structured to penetrate the coaxial cable between an inner cable portion and an outer cable portion. The mandrel defines an inner passageway to receive the inner cable portion therethrough including an inner cable conductor extending into the passage of the fastener. The device is structured to move along the axis relative to the body over a range defined by opposing stop surfaces prior to secured connection to the coaxial cable.

While the invention has been illustrated and described in detail in the drawings and foregoing description, the same is to be considered illustrative and not restrictive in character, it being understood that only selected embodiments have been shown and described and that all changes, equivalents, and modifications that come within the scope of the inventions described herein and/or by the following claims are desired to be protected. Any experiments, experimental examples, or experimental results provided herein are intended to be illustrative of the present invention and should not be construed to limit or restrict the invention scope. Further, any theory, mechanism of operation, proof, or finding stated herein is meant to further enhance understanding of the present invention and is not intended to limit the present invention in any way to such theory, mechanism of operation, proof, or finding. In reading the claims, words such as “a”, “an”, “at least on”, and “at least a portion” are not intended to limit the claims to only one item unless specifically stated to the contrary. Further, when the language “at least a portion” and/or “a portion” is used, the claims may include a portion and/or the entire item unless specifically stated to the contrary.

What is claimed is:

1. A method, comprising:
providing a connector assembly including a body defining a chamber intersecting an opening, a fastener rotatably connected to the body and including an inner surface defining threading and a passage intersecting the chamber opposite the opening, and a cable engagement device inside the chamber that includes a mandrel with a head and defines an inner passageway therethrough;
inserting a coaxial cable through the opening, the coaxial cable including an outer insulator, an inner insulator, an outer electrical conductor positioned between the outer insulator and the inner insulator, and an inner electrical conductor extending through the inner insulator;
engaging the threading with a threaded connection component to advance the connection component through the passage and generate a force that is applied to the head; and
in response to the force, moving the cable engagement device through the chamber to push the mandrel between the outer insulator and the inner insulator and receive the inner insulator and the inner conductor in the inner passageway.

2. The method of claim 1, which includes inserting the inner conductor through an aperture in the connection component.

3. The method of claim 1, which includes securing at least a portion of the mandrel in the cable with a number of barbs.

4. The method of claim 1, wherein the cable engagement device includes a retainer, and further comprising:
slidingly engaging an interior wall of the body with the retainer;
defining a cavity between the retainer and the mandrel; and
receiving the outer insulator and at least a portion of the outer conductor in the cavity.

5. The method of claim 1, wherein the chamber is tapered between the opening and the mandrel.

6. The method of claim 1, wherein the fastener has a knurled outer surface opposite the inner surface and the engaging the threading includes rotating the fastener relative to the body about a longitudinal axis of the assembly by finger contact with the knurled outer surface.

7. The method of claim 1, which includes:
preparing an end portion of the coaxial cable before insertion through the opening;
inserting the inner conductor through an aperture in the connection component; and
securing the mandrel in the cable with a number of barbs;
providing the cable engagement device with a retainer member;
slidingly engaging an inner wall of the body with the retainer;
defining a cavity between the retainer and the mandrel; and
receiving at least a portion of the outer insulator in the cavity.

8. Apparatus, comprising:
a tubular body extending along an axis, the tubular body defining a chamber and including a first end portion opposite a second end portion, the first end portion defining an opening to the chamber, the opening being structured to receive a coaxial cable therethrough;
a fastener connected to the second end portion with a rotational coupling to turn about the axis relative to the body, the fastener including a inner surface defining threading about the axis and a passage therethrough, the passage intersecting the chamber of the body; and
a cable engagement device captured within the chamber of the body, the device including a retainer that slidingly engages the body and a mandrel, including a head positioned opposite a cable penetration end, the head being closer to the passage of the fastener than the cable penetration end, the penetration end being structured to penetrate an end of the coaxial cable between an inner cable portion and an outer cable portion, the mandrel defining an inner passageway to receive the inner cable portion therethrough, and the device being structured to move along the axis relative to the body over a range defined by opposing stop surfaces prior to secured connection to the coaxial cable.

9. The apparatus of claim 8, wherein the cable penetration end includes a number of barbs to secure connection to the coaxial cable.

10. The apparatus of claim 8, wherein the chamber is tapered between the cable penetration end and the opening.

11. The apparatus of claim 8, wherein the retainer and the mandrel are structured to define a cavity therebetween to receive at least a portion of an outer insulator of the coaxial cable when the cable penetration end engages the coaxial cable.

12. The apparatus of claim 8, wherein the body, the fastener, and the cable engagement device each have an approximately circular cross section taken along the axis, and the body, the fastener, and the cable engagement device are each generally symmetric about the axis.

13. The apparatus of claim 8, wherein the rotational coupling is provided by a circumferential channel defined in the body and a lip of the fastener rotatably engaged in the channel.

14. The apparatus of claim 8, wherein the fastener has a knurled outer surface opposite the inner surface.

15. The apparatus of claim 8, further comprising means for securing the mandrel in the cable and means for defining a cavity between the retainer and the mandrel.

16. An assembly, comprising:
a threaded connection component;
a coaxial cable including an outer insulator, an inner insulator, an outer electrical conductor positioned between the outer insulator and the inner insulator, and an inner electrical conductor extending through the inner insulator;
a coaxial cable connector, including:
a tubular body defining a chamber and an opening intersecting the chamber, the opening receiving the coaxial cable therethrough;
a fastener rotatably connected to the body opposite the opening and including internal threading engaged by the threaded connection component; and
a cable engagement device captured within the chamber that includes a mandrel with a head, the mandrel penetrating an end portion of the coaxial cable and being secured between the outer insulator and the inner insulator thereof in response to compressive force exerted on the head, the compressive force resulting from advancing the threaded connection component into the fastener.

17. The assembly of claim 16, wherein an end of the inner conductor extends through an aperture defined by the connection component.

18. The assembly of claim 16, wherein the mandrel includes a number of barbs to secure engagement between the outer insulator and the inner insulator.

19. The assembly of claim 17, wherein the cable engagement device includes a retainer member slidingly engaged to the body, the retainer and the mandrel defining a cavity therebetween, and at least a portion of the outer insulator being positioned in the cavity.

20. The apparatus of claim 19, wherein the chamber is tapered between the opening and the mandrel and the fastener includes a knurled outer surface.
